(19) United States
(12) Patent Application Publication
(10) Pub. No.: US 2026/0338737 A1
(43) Pub. Date: Oct. 29, 2026

(54) Metal Detector and Method for Detecting Metals in Objects to be Conveyed

(71) Applicant: Institut Dr. Foerster GmbH & Co., KG, Reutlingen (DE)

(72) Inventors: Michael SPAHLINGER, Dusslingen (DE); Lisa ROETHLINGSHOEFER, Reutlingen (DE); Uri Johannes MUELLER, Reutlingen (DE)

(21) Appl. No.: 19/106,006

(22) PCT Filed: Aug. 7, 2023
(86) PCT No.: PCT/EP2023/071836

§ 371 Date: Feb. 24, 2025

(30) Foreign Application Priority Data
Aug. 24, 2022 (DE) 10 2022 208 758.5

(51) Int. Cl. G01N 27/82

(52) U.S. Cl. CPC G01N 27/82

(57) ABSTRACT

A metal detector detects electromagnetically detectable constituents in objects to be conveyed that pass through a detection zone of the metal detector in a conveying direction along a conveying section. The metal detector includes a support structure that defines a passage channel for the objects to be conveyed. The passage channel extends in a longitudinal direction of the support structure, the longitudinal direction being alignable parallel to the conveying direction, from an entrance to and an exit. A coil system having a plurality of coils is provided, the coils being arranged on the support structure and defining the detection zone between the entrance and the exit. The coils include transmitting coils and receiver coils. A first transmitting coil arrangement serves for generating a first excitation field in a first field direction oriented transversely with respect to the longitudinal direction, the first transmitting coil arrangement having first transmitting coils which are excitable in-phase, are arranged on opposite sides outside the passage channel and have coil axes oriented transversely with respect to the longitudinal direction. A second transmitting coil arrangement serves for generating a second excitation field in a second field direction oriented transversely with respect to the longitudinal direction, the second transmitting coil arrangement having second transmitting coils which are excitable in-phase, are arranged on opposite sides outside the passage channel and have coil axes oriented transversely with respect to the longitudinal direction. The second transmitting coil arrangement is arranged offset relative to the first transmitting coil arrangement in the longitudinal direction. The second field direction is opposite to the first field direction.

### BACKGROUND AND SUMMARY

The invention relates to a metal detector for detecting electromagnetically detectable constituents in objects to be conveyed which comprise components made of materials of different electromagnetic properties and pass through a detection zone of the metal detector in a conveying direction along a conveying section.

A metal detector of the type considered in this application operates according to an electromagnetic principle and as a result is able to recognize or detect materials or parts on the basis of their electrical conductivity and/or magnetic conductivity (permeability) and to also distinguish the different constituents from one another if there are sufficiently great differences between these electromagnetic properties. The term “metal detector” relates to the suitability for detecting metals (as typical representatives of materials with a relatively high electrical conductivity) in objects to be conveyed possibly containing materials which have a worse conductivity or are not conductive at all.

Possible fields of use of metal detectors are found, for example, in the field of the food industry, the pharmaceuticals industry, the plastics industry or more generally the chemical industry or the packaging industry. A purpose of using metal detectors in these fields of application is to quickly and reliably detect the presence of undesirable pieces of metal in objects to be conveyed which otherwise predominantly or exclusively consist of electrically non-conductive or only weakly electrically conductive material. The objects to be conveyed may be piece goods, that is to say items that can be individually transported “in one piece”, or possibly bulk goods. Such metal detectors are widespread in the industrial sector and are often integrated in production lines or packaging lines.

A non-limiting application example is food monitoring on the conveyor belt. This is specifically the detection of very small metal particles which result in contamination during food processing and/or food packaging.

Another field of use is in the field of material sorting, in particular metal sorting, which may involve, for example as part of recycling processes, separating parts made of electrically highly conductive non-ferrous metals such as copper, aluminum or their alloys from mixtures containing constituents made of metals with poor electrical conductivity and/or non-metals.

So-called tunnel metal detectors are nowadays frequently used as standard. In addition to their simple design, conventional tunnel detectors provide, inter alia, high sensitivity and robustness and have therefore been regarded as standard in food monitoring for years. However, they also have various disadvantages, including a relatively large space requirement on the belt on account of extensive metal-free zones (MFZ) and the resulting necessary product rectification during detection. An MFZ is that region upstream and downstream of the ends of the tunnel which must remain free of metal parts in order to avoid disrupting detection in the detection zone. Moving metal parts are particularly critical.

Document EP 2 729 831 B1 discloses a conventional tunnel metal detector with a metal housing having a rectangular inlet opening and a rectangular outlet opening. Inside the housing, there is a coil system having at least one transmitter coil that can be excited with alternating current, at least one first receiver coil and at least one second receiver coil. These coils delimit, in the direction of travel, a detection zone which extends between the inlet opening and the outlet opening and through which the items to be examined move. The transmitting coil and the receiver coils surround the “tunnel” which runs between the inlet opening and the outlet opening and through which the objects to be conveyed pass. In one embodiment, cancellation devices are arranged at the inlet opening and at the outlet opening in order to cancel the electromagnetic primary field generated by the transmitter coil. This makes it possible to reduce the extent of the “metal-free zone” (MFZ).

Document DE 44 24 058 C1 discloses a device which is constructed in the form of a tunnel detector and is intended to generate a recognition signal when metallically conductive parts occur in a conveying stream that is at least substantially non-conductive, in which an AC generator builds up, via a transmitting coil in a section of the conveying stream to be monitored, an alternating electromagnetic field, the amplitude and phase changes of which are captured by means of a coil system feeding an evaluation circuit in order to derive the recognition signal. The coil system consists of at least two individual systems which each comprise a transmitting coil and receiving coils, and one of which is arranged, based on the conveying stream, in such a manner that the magnetic field of its transmitting coil runs predominantly in the direction of the conveying stream and at least one other of which is arranged such that the magnetic field of its transmitting coil runs predominantly transversely to the direction of the conveying stream. Each of the individual systems is provided with an evaluation circuit and the signal outputs of the evaluation circuits are connected to an evaluation logic circuit that is designed to carry out an object-specific evaluation on the basis of the signals supplied to it. The device is intended to be particularly sensitive to small and elongate parts, for example for short pieces of wire or wire nails.

Against this background, it is an object of the present invention to provide a metal detector and a method for detecting metals which, in comparison with the prior art, with compact dimensions and only small metal-free zones, take up only very little installation space for integration in a conveying section and do not require any or only moderate product rectification for reliable detection.

In order to achieve this object, the invention provides a metal detector and a method having the features of the independent claims. Advantageous developments are specified in the dependent claims. The wording of all claims is incorporated by reference in the content of the description.

According to one formulation, the invention relates to a metal detector for detecting electromagnetically detectable constituents in objects to be conveyed which comprise components made of materials of different electromagnetic properties and pass through a detection zone of the metal detector in a conveying direction along a conveying section. In some applications, the objects to be conveyed consist predominantly of electrically non-conductive or only weakly electrically conductive material and the parts to be detected are pieces of metal with a comparatively higher electrical conductivity relative thereto which represent unwanted foreign objects in these objects to be conveyed.

The conveying section preferably runs more or less horizontally. For example, a conveyor belt may be guided through the detection zone in such a way that the objects to be conveyed lying on the top side of the conveyor belt are conveyed through the detection zone of the metal detector. Other conveying directions in space are possible.

The metal detector has a support structure that defines a passage channel for the objects to be conveyed. The passage channel runs in a longitudinal direction of the support structure from an inlet to an outlet for the objects to be conveyed. The metal detector is normally arranged in relation to the conveying direction such that the longitudinal direction of the support structure is oriented parallel or substantially parallel to the conveying direction.

The transverse direction of the support structure is oriented perpendicular to the longitudinal direction. The height direction of the support structure is perpendicular to the plane spanned by the longitudinal and transverse directions. In most applications, the longitudinal and transverse directions are in a horizontal plane, perpendicular to which a (vertical) height direction of the support structure runs. Other orientations in space are possible.

The usable width of the passage channel in the transverse direction is adapted to the width of the conveying device in such a way that each conveyed item passes through the detection zone. The height of the passage channel is usually less than its width and can be oriented to the maximum height of the conveyed objects to be conveyed which should pass through the passage channel. Often, the passage channel has a flat rectangular cross section whose width (in the transverse direction) is significantly greater than its height, for example at least twice as great or at least five times as great. However, deviations from this are possible.

The metal detector uses the generation and detection of eddy currents in electrically conductive materials, e.g. metals, to detect the conductive parts according to the transmitter-receiver principle. For this purpose, the metal detector comprises a coil system having a multiplicity of coils which are arranged on the support structure and define the detection zone between the inlet and the outlet. The coils include transmitting coils and receiver coils.

An essential function of the support structure is to ensure that the coils of the coil system attached to it have a fixed spatial assignment. The support structure may be an accordingly mechanically stable assembly which may possibly be transported as a whole and can be installed together with the coils attached to it at the place of use. However, the components of the support structure do not need to be directly connected to each other. It is also possible for supporting components of the support structure to be mounted on a room wall, a ceiling or on the floor of a room and to be held in a fixed spatial relationship with each other only via structural components of a building containing the room. For example, one part of the support structure may be suspended from a ceiling, while another part is on the floor.

According to one formulation of the invention, the coil system comprises a first transmitting coil arrangement and a second transmitting coil arrangement. The first transmitting coil arrangement is configured such that, during operation, it can generate a first excitation field in a first field direction oriented transversely, in particular perpendicular, to the longitudinal direction. For this purpose, the first transmitting coil arrangement has two first transmitting coils which can be excited in phase, are arranged on opposite sides outside the passage channel and have coil axes oriented transversely, in particular perpendicular, to the longitudinal direction.

Furthermore, there is (at least) a second transmitting coil arrangement for generating a second excitation field in a second field direction oriented transversely, in particular perpendicular, to the longitudinal direction, wherein the second transmitting coil arrangement has two second transmitting coils which can be excited in phase, are arranged on opposite sides outside the passage channel and have coil axes oriented transversely, in particular perpendicular, to the longitudinal direction. The second transmitting coil arrangement is arranged with an offset in the longitudinal direction with respect to the first transmitting coil arrangement. The second field direction is opposite the first field direction.

The transmitting coils are connected to an AC voltage source during operation and generate a preferably permanent alternating electromagnetic field, the main field component of which is directed transversely, in particular perpendicular, to the longitudinal direction of the passage channel. The alternating electromagnetic field induces, in a receiver coil, electrical voltages which are evaluated by means of a connected evaluation device. As soon as an electrically conductive part, in particular a piece of metal, enters the detection zone, eddy currents are generated in the part by the alternating electromagnetic field of the transmitting coils and act on the receiver coil by mutual induction. This means that entering metal parts cause a disturbance in the alternating field, which is detected by the receiver coil. The evaluation device processes the corresponding signals, evaluates them and reports under precisely definable conditions the presence of electrically conductive, in particular metallic, contamination in the objects to be conveyed.

The term “coil axis” in this application denotes a direction perpendicular or substantially perpendicular to a winding plane defined by the course of a winding of a coil. In the case of flat coils with windings running helically in a common winding plane, the coil axis is oriented perpendicular to the winding plane. If the windings in a coil are run spirally, the coil axis is given by the longitudinal axis of the spiral and, depending on the slope of the spiral, runs only approximately perpendicular to a winding plane.

The “field direction” is that direction in space in which the main component of the alternating electromagnetic fields generated by a transmitting coil arrangement is directed. A transmitting coil can also be referred to as a “field coil” or “excitation coil”. The alternating electromagnetic field generated by the transmitting coil is also referred to here as an excitation field or as a transmitting field or primary field.

Preferably, there are exactly two transmitting coil arrangements arranged one after the other in the longitudinal direction. However, one or more further transmitting coil arrangements may also be provided if required, i.e. a total of, for example, three or four transmitting coil arrangements.

In comparison with conventional tunnel metal detectors, there are significant structural and functional differences which are expressed, among other things, in the type of orientation and arrangement of the coils and bring specific technical advantages.

In the conventional tunnel metal detectors, there is at least one transmitting coil which completely surrounds the passage channel for the objects to be conveyed and accordingly has a coil axis running in the longitudinal direction of the passage channel, i.e. substantially parallel to the conveying direction of the objects to be conveyed. In contrast, a metal detector of the type described herein preferably does not have a transmitting coil which surrounds the passage channel and has a coil axis directed in the longitudinal direction.

In contrast to a transmitting coil surrounding the passage channel, the first and second transmitting coils thus have an orientation rotated by 90°, with the result that, so to speak, a focus is created transversely, in particular perpendicular, to the conveying direction. The term “focus” in this case refers to the direction in which the main excitation field is oriented (the first and second field directions).

This orientation can be used to ensure that essentially only those metal objects which are located within the detection zone, i.e. between the inlet and the outlet, can trigger a detection signal. If, on the other hand, moving metal items are located outside the detection zone, they generate virtually no detection signals, even if they are close to the inlet or outlet. The so-called metal-free zone (MFZ), i.e. that region upstream or downstream of the ends of the passage channel which must remain free of metal parts in order to avoid disturbing the detection in the detection zone, is thus considerably shorter or smaller compared to conventional metal detectors and can be completely omitted if necessary, with the result that possibly moving metal parts can also be attached at a small distance directly upstream of the inlet or directly downstream of the outlet. This means that, when such a metal detector is integrated in a production line or conveyor line in the axial direction, only a small amount of “metal-free” installation space is required, which facilitates integration in the line.

Another major advantage is that, due to the arrangement of the two transmitting coil arrangements connected in series in the conveying direction, only elements within the detection zone provide a significant evaluation effect and thus shorter product distances are possible in the longitudinal direction. The term “product distance” in this case refers to the distance between products that should be maintained so that the metal detection can clearly assign any signals to one or the other product. If the products are axially too close to each other, it cannot be inferred from a detection signal which of the products contains the signal-triggering contamination. There are therefore considerable advantages in terms of the product distances required for reliable detection in the conveying direction or axial direction, so that more products per unit of time can be reliably examined at an unchanged conveying speed.

The first and second transmitting coil arrangements are differentially connected or can be differentially operated. In other words, the first excitation field and the second excitation field are phase-shifted by 180° in relation to each other. This can be achieved, for example, by virtue of the fact that the two transmitting coils arranged on the same side of the passage channel (a first transmitting coil and a second transmitting coil) are electrically connected in series, but have an opposite winding sense, with the result that the excitation current running through both transmitting coils generates opposing fields of the two coils. It would also be possible to design the windings of the first and second transmitting coils on one side to be in the same direction and to ensure the required 180° phase shift by means of actuation using an AC source.

According to this configuration, two excitation fields with opposite field directions, which are connected in series in the conveying direction and are substantially homogeneous over the width and height of the passage channel, can be generated in the detection zone. Figuratively speaking, the objects to be conveyed pass in direct temporal succession through two excitation field curtains with opposite field directions.

The differential circuit can increase sensitivity and even the smallest particles can be detected. In addition, the detection signals that are generated when passing through the detection zones now also provide information about the position of the objects to be conveyed in the conveying direction, thus creating a spatial resolution in the conveying direction.

A symmetrical structure is advantageous for this. According to one development, the first transmitting coil arrangement and the second coil arrangement are designed to be substantially axially symmetrical to an axis of symmetry that runs between the coil arrangements perpendicular to their field direction.

It is possible to use only a single receiver coil that covers the full width of the detection zone. Preferred embodiments, on the other hand, are characterized in that the receiver coils have a first receiver coil and at least one second receiver coil which are arranged together on one side (outside the) passage channel beside one another with an offset with respect to one another in the transverse direction oriented perpendicular to the longitudinal direction, wherein these receiver coils have coil axes oriented transversely, in particular perpendicular, to the longitudinal direction.

Thus, a plurality of receiver coils, i.e. two, three, four or more receiver coils, are provided and are arranged on the same side outside the passage channel. The plurality of receiver coils are arranged with an offset with respect to one another in the transverse direction. While the transmitting coils extend over the full width of the passage channel in the transverse direction such that during operation the transmitting coils generate their excitation field over the entire width of the detection zone, each of the receiver coils in the transverse direction covers only a part of the width of the passage channel, in particular not more than half the width, possibly also less than 50% of the width, e.g. approximately 33% or approximately 25% or approximately 20% or approximately 12% to 13%. In other words, the receiver coils define two, three, four or more adjacent detection sectors in the transverse direction. Thus, the coil arrangement comes to have location-dependent sensitivity relative to the transverse direction, with the result that, when evaluating the signals from the receiver coils, it is possible to determine whether the signal-triggering metal part has essentially passed through the region or detection sector monitored by the first receiver coil or the region monitored by the second receiver coil. Thus, it is also possible to permit shorter product distances in the transverse direction than in the prior art, thus further increasing the detection capacity of the metal detector.

It is possible for the coil arrangement to have receiver coils only on one side outside the through-channel, e.g. below the through-channel. Preferably, provision is made for the coil system to have, for each receiver coil on one side, a further receiver coil on that side of the passage channel which is opposite this side. Two receiver coils which are assigned to one another and are arranged on different sides respectively form a receiver coil pair (i.e. a pair of two receiver coils which are assigned to one another on opposite sides of the through-channel).

If more than one receiver coil is provided on one side, that is to say a first receiver coil and at least one second receiver coil offset in comparison in the transverse direction, a corresponding number of receiver coil pairs is preferably provided.

Preferably, provision is made for the first and second receiver coils in a receiver coil pair, which are arranged on opposite sides, to each have coaxial coil axes. When viewed in the transverse direction, there may therefore be, for example, two, three, four or more pairs of receiver coils that are coaxially opposite one another.

In addition to the spatial resolution in the transverse direction, a spatial resolution in the height direction, i.e. in the direction between the two receiver coils, is thus also possible. This is because the detection signals from the mutually opposite receiver coils in a sector can be used to determine whether the detected item passes through the passage channel closer to the one receiver coil or closer to the receiver coil which is coaxially opposite it, for example.

Thus, the passage channel can be divided into two detection sectors in that direction in which a receiver coil and the associated further receiver coil are coaxially opposite. In the transverse direction perpendicular thereto, the number of sectors can correspond to the number of receiver coils arranged side by side. Preferably, four receiver coils are provided in the transverse direction, with the result that preferably the detection channel can be divided into eight detection sectors (four in the transverse direction by two in the height direction). A finer subdivision is theoretically possible, but usually not necessary.

However, a coaxial arrangement is not the only option. The receiver coils in a pair can also be arranged with an offset with respect to one another laterally (i.e. in the transverse direction). For example, it may be the case that a first receiver coil on one side is opposite a transition region between two second further receiver coils on the opposite side. Thus, if appropriate, in the case of a given number of laterally offset receiver coils on one side, the spatial resolution in the transverse direction may be finer than in the case of a coaxial arrangement of the receiver coils in a pair.

In order to ensure reliably seamless detection of products passing through in the transverse direction, provision is made in preferred embodiments for receiver coils which are directly adjacent and are arranged with an offset with respect to one another in the transverse direction to directly adjoin one another or partially overlap in an overlapping region. This can prevent sensitivity dips, which could pose a safety risk, from being produced in the transverse direction.

According to one development, provision is made for a receiver coil, in particular every first and second receiver coil, to respectively surround a coil surface that extends in the longitudinal direction over the first coil arrangement and the second coil arrangement in such a manner that, in the absence of a field disturbance, the first and second excitation fields induce equal and opposite voltages in a receiver coil. Thus, each receiver coil is intrinsically compensated and no voltage is induced in it, as long as the field distribution in the detection zone is not disturbed asymmetrically by metal parts or the like. This can increase the sensitivity of the arrangement.

The coils can be in the form of coils wound from wire. According to one development, the components of the coil arrangement are produced in the form of printed circuits using PCB technology methods. In particular, it can be the case that coils in the coil arrangement are arranged in the form of rectangular flat coils with helically running windings in different coil layers of a multilayer arrangement, wherein an insulating layer made of electrically insulating material is respectively arranged between adjacent coil layers of the multilayer arrangement. A coil can have windings in a plurality of layers in order to achieve a sufficient number of windings in limited lateral space. Such coil arrangements allow the metal detector to be constructed in a compact, relatively light and yet stable manner compared to the state of the art. This makes handling easier, among other things.

To further improve the function, the metal detector in some embodiments has field shaping elements made of soft magnetic material which are arranged outside the coil arrangements at least in the region of the transmitting coil arrangements and are preferably attached to the support structure. The field shaping elements can be formed by ferrite plates or have ferrite plates, for example.

A plurality of effects can be achieved by means of the field shaping elements. On the one hand, the outside space is shielded against alternating fields generated by the transmitting coils. The shielding also acts in the opposite direction, with the result that the interior or the detection zone is shielded from the outside against possible electromagnetic interference fields. In addition, an effect of inward field concentration is achieved, with the result that the field strength achievable by the transmitting coils in the region of the detection zone is increased compared to variants without field shaping elements.

If necessary, field shaping elements could be attached to all sides of the detection channel, surrounding the detection channel on all sides adjacent to the passage channel.

Furthermore, the metal detector may have at least one electric field shield, that is to say a shield which acts against the penetration of electric fields into the detection zone. In variants with multilayer arrangements, the electric field shield may be integrated in a layer of the multilayer structure containing the coil arrangement. This can further increase sensitivity, since external electric fields cannot or cannot significantly affect signal generation.

The concept according to the claimed invention offers not only technical advantages in the field of detection possibilities, but also in general handling, in particular also with regard to integration in conveying sections. The fact that the coil system does not require, and therefore preferably also does not have, a transmitting coil or receiver coil surrounding the passage channel and with a coil axis directed in the longitudinal direction, it is very easily possible to improve the lateral accessibility of the conveying section in the region of the metal detector. In some exemplary embodiments, the support structure has, at least on one side, an access opening through which the passage channel is laterally accessible. The access opening can be permanently open. It is also possible for a closure element to close the access opening for normal operation in order to mechanically stabilize the support structure, if necessary. If necessary, the closure element can be easily removed such that the passage channel is laterally accessible. As a result, maintenance work or replacement of a conveyor belt or the like is very easily possible, since the elongated conveying element no longer has to be threaded through a through-channel closed in the circumferential direction, but can be easily inserted or removed from the side at a suitable location.

### BRIEF DESCRIPTION OF THE DRAWINGS

Further advantages and aspects of the invention emerge from the claims and from the description of exemplary embodiments of the invention which are explained below with reference to the figures.

### BRIEF DESCRIPTION OF THE DRAWINGS

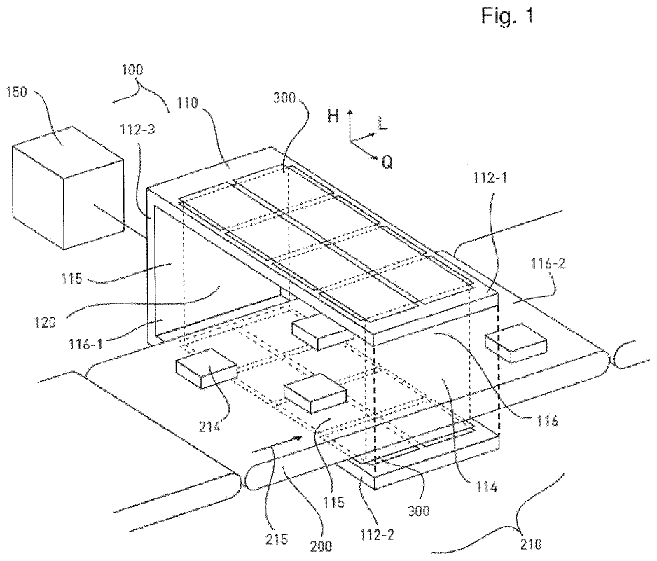

FIG. 1 shows an embodiment of a metal detector which is integrated in a conveying section of a conveyor system;

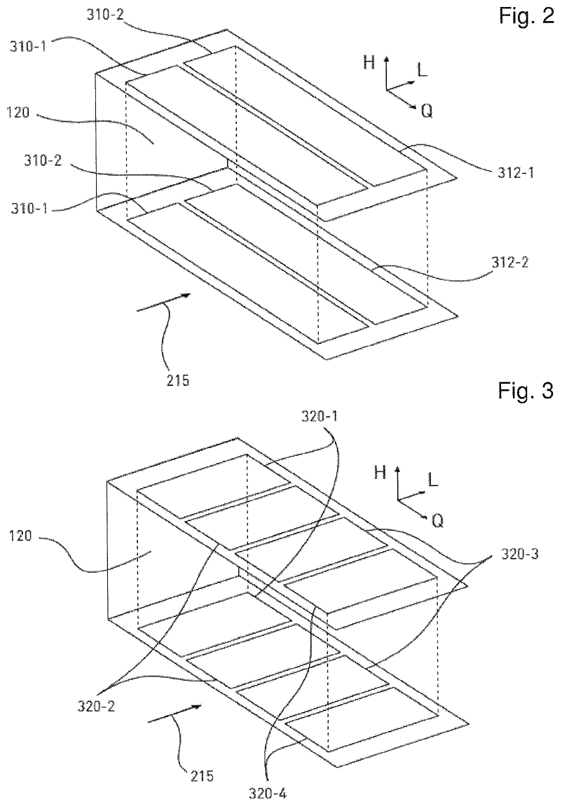

FIG. 2 shows an isolated representation of only the transmitting coil arrangements;

FIG. 3 shows an isolated representation of only the receiver coil pairs;

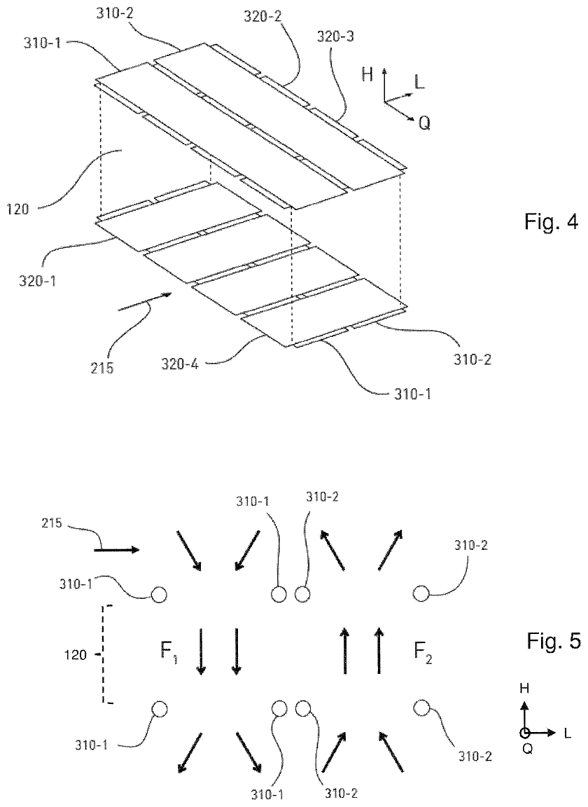

FIG. 4 shows the relative spatial arrangement of the coils with respect to each other without a support structure;

FIG. 5 schematically illustrates the field distribution generated by the transmitting coils within the detection zone;

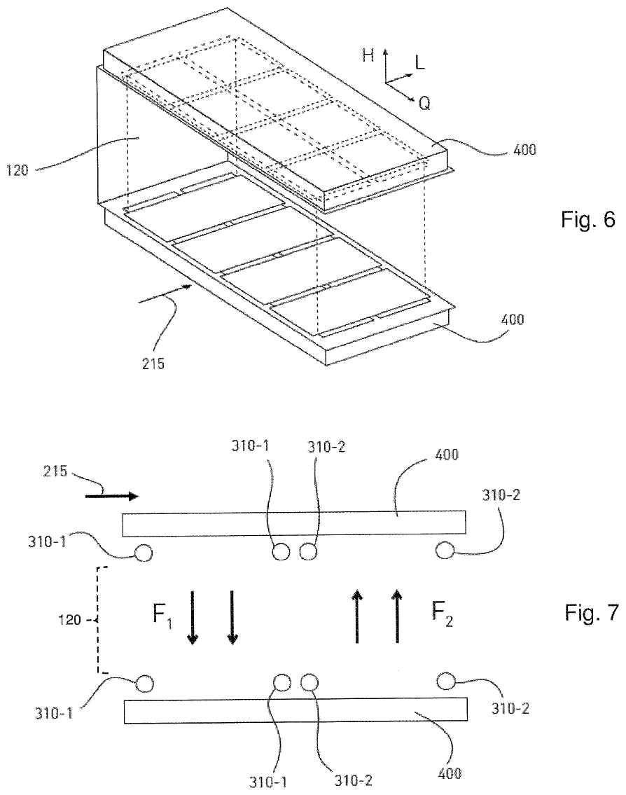

FIG. 6 shows the metal detector with soft magnetic field shaping elements;

FIG. 7 illustrates the influence of the field shaping elements on the field distribution.

### DETAILED DESCRIPTION OF THE DRAWINGS

Important aspects of a novel metal detector are explained by way of example below using an example from the field of monitoring objects to be conveyed in the food industry.

The metal detector generates electromagnetic fields and evaluates their interaction with objects to be conveyed that are passing through. The metal detector is thus able to recognize or detect materials or parts on the basis of their electrical and/or magnetic conductivity and to reliably distinguish the different constituents of the objects to be conveyed from one another if there are sufficiently great differences in these electromagnetic properties.

Schematic FIG. 1 shows an oblique perspective of a metal detector 100 which is integrated in a conveying section 210 of a conveyor system 200. The conveyor system has a plurality of conveyor modules which are connected in series and as a whole form a substantially horizontal conveying section 210 in order to convey objects to be conveyed 214 in the form of food-filled cartons 214 at the end of a production line in a conveying direction 215 and to subject them to a final inspection. The contents of the cartons should be free of metal contaminants, and the cartons themselves are produced from cardboard, for example, without the use of metal materials.

In order to ensure that the cartons coming onto the market do not contain any metal foreign objects that could have entered the cartons during the processing of the food, for example, due to faults in operation or in the installations, the final inspection includes in-line testing of all cartons in order to detect any metal parts present in objects to be conveyed that ideally consist exclusively of electrically non-conductive material. The conveying section may contain further test modules, for example a downstream load cell for determining whether the filling weight of the cartons is within the setpoint range.

The metal detector 100 has a support structure 110 which is essentially composed of relatively thick plates of electrically non-conductive, torsion-resistant plastic, e.g. a thermoset material. An upper support plate 112-1 extends above the conveying section in the transverse direction Q of the support structure horizontally and perpendicular to the conveying direction 215. A lower support plate 112-2 extends below the conveyor belt parallel to the upper plate in the transverse direction Q. The plates are connected on the rear side in FIG. 1 via a stable vertical plate 112-3, thus resulting in a rectangular U-shape in the cross section perpendicular to the conveying direction 215. On the front side of the support structure visible at the front in FIG. 1, this support structure is open and thus offers, between the horizontal plates, an access opening 114, through which the conveying section 210 is accessible from the side. For stabilizing the support structure, the access opening 114 may be closed during operation by one or more closure elements 116, e.g. a vertical plate, which connect the upper plate 112-1 to the lower plate and thereby stabilize the substantially rectangular support structure.

The longitudinal direction L of the support structure is ideally oriented parallel to the conveying direction 215, the transverse direction Q perpendicular thereto is oriented transversely to the conveying direction in the horizontal direction, and the vertical direction is referred to as the height direction H. A passage channel 115 for the objects to be conveyed is formed between the upper and lower plates of the support structure and leads in the longitudinal direction L from an inlet 116-1 to an outlet 116-2.

The metal detector 100 has a coil system 300 comprising numerous coils which are supported by the support structure 110 and are illustrated only schematically in FIG. 1. The coils include transmitting coils for exciting an alternating electromagnetic field in the region through which the objects to be conveyed pass and receiver coils for detecting metal parts that can interfere with the field distribution. That region in the passage channel of the metal detector which is intended to be captured for detection purposes and comprises the entire width of the conveyor belt in the transverse direction is also referred to here as a detection zone 120.

The individual coils and their arrangement and function are explained below with reference to FIG. 1 and further figures. The coil system 300 comprises two transmitting coil arrangements (first transmitting coil arrangement 310-1, second transmitting coil arrangement 310-2) connected in series in the longitudinal direction L and four pairs of receiver coils 320-1 to 320-4 which are arranged beside one another with an offset in the transverse direction. For better illustration, FIG. 2 shows only the two transmitting coil arrangements, FIG. 3 shows only the receiver coil pairs and FIG. 4 shows the relative spatial arrangement of the coils with respect to each other without a support structure. FIG. 5 schematically illustrates the field distribution generated by the transmitting coils within the detection zone.

The first transmitting coil arrangement 310-1, which is closer to the inlet, generates a first excitation field during operation, the field lines of which are oriented inside the detection zone in a first field direction F1 which runs transversely, in particular perpendicular, to the longitudinal direction L in the vertical direction. To achieve this, the first transmitting coil arrangement has a pair of first transmitting coils 312-1, 312-2, wherein one of the transmitting coils is arranged above and the other below the passage channel 115 (and below the conveying section 210). These two transmitting coils are thus located on opposite sides outside (i.e. above or below) the passage channel. Their coil axes running perpendicular to the winding plane are oriented perpendicular to the longitudinal direction L, i.e. parallel to the height direction H. The first transmitting coils extend in the transverse direction to the left and right beyond the end of the detection zone 120. During operation, they are operated with AC voltage of identical phase, with the result that a largely homogeneous alternating electromagnetic field is formed between the first transmitting coils in a first field direction F1.

A second transmitting coil arrangement 310-2 is arranged with an offset with respect to the first transmitting coil arrangement in the longitudinal direction L and has a similar structure with second transmitting coils above and below the passage channel 115. The first and second transmitting coils on one side are electrically connected in series, but their winding sense is opposite, with the result that the second excitation field generated by the second transmitting coil arrangement 310-2 has a second field direction F2 which always runs counter-parallel to the first field direction F1.

FIG. 5 schematically shows the result of a simulation of the field distribution. It can be seen that the fields are each largely homogeneous in the region of the transmitting coils. Objects to be conveyed that are passing through thus pass first through the “curtain” of an alternating electromagnetic field generated by the first transmitting coil arrangement 310-1. After passing through a plane of symmetry between the two transmitting coil arrangements, the objects to be conveyed then pass through a second curtain of an electromagnetic field with an opposite field direction F2.

The receiver coils 320 form a total of four pairs of receiver coils which are offset with respect to one another in the transverse direction and can be seen in FIG. 3 in a manner isolated from the other coils. Each of the receiver coils extends in the longitudinal direction symmetrically over both transmitting coil arrangements 310-1, 310-2 connected in series, and so these do not induce a voltage in the receiver coil in the absence of metal parts that interfere with the magnetic field. The first receiver coils 320-1 in the first pair have coil axes that are coaxial to each other. With an offset in the transverse direction Q, there follows a pair of second receiver coils 320-1 with a similar structure. The directly successive receiver coils overlap slightly in the transverse direction Q (e.g. by a maximum of 10% of their width), with the result that there are no sensitivity gaps between the detection sectors covered in each case.

The total width in the transverse direction monitored by the receiving coils 320 determines the width of the detection zone 120. This is divided as it were into four adjacent detection sectors by the four receiver coil arrangements.

The metal detector 100 comprises a control unit 150 which comprises an AC voltage source, controls the two transmitting coil arrangements 310-1, 310-2 and thus generates the excitation fields. The receiver coils 320-1 to 320-4 are connected to an evaluation unit of the control device 150.

The special type of arrangement of transmitting coils and receiver coils offers numerous advantages. The coil axes of all transmitting coils are perpendicular to the direction of travel or to the conveying direction 215, with the result that the excited fields of the detection zones also permeate them in the vertical direction. This allows the metal-free zones upstream of the inlet 116-1 and downstream of the outlet 116-2 to be kept relatively narrow. The differential circuit of the transmitting coil arrangements 310-1, 310-2 connected in series in the longitudinal direction makes it possible, on the one hand, to increase the detection sensitivity, since a metal part must be recognizable from the fact that it must generate comparable signals (with reversed signs) both when passing through the first field curtain and when subsequently passing through the second field curtain. Furthermore, a spatial resolution is obtained in the longitudinal direction L, thus making it possible to allow a relatively short product distance between the individual products (here: food cartons) in the longitudinal direction without having to fear that defective products will remain undetected.

Furthermore, a spatial resolution is also obtained in the transverse direction Q by providing a plurality of receiver coil pairs, since it can be identified whether a product passing through is more likely to pass through in the region of a first receiver coil pair or in the region of the adjacent second receiver coil pair, etc. Thus, a large product distance is not necessary even in the transverse direction Q.

Finally, there is also a spatial resolution in the height direction H, since it is possible to identify, by comparing the signal strengths of the upper receiver coil and of the lower receiver coil in a pair of receiver coils, whether the product runs along closer to the lower receiver coil or closer to the upper receiver coil.

In total, the metal detector 110 of the exemplary embodiment thus has eight detection sectors which can be distinguished during evaluation, whereby exactly that product passing through in which a significant interference signal is detected can be identified at any time.

The components of the metal detector (support structure and coils attached to it) to be attached to the region of the conveying section 210 are of a compact design, are easy to handle due to their low weight and can be easily integrated in a conveying section. A contribution to this is made by the fact that the combination of transmitting and receiver coils, which are to be arranged on one side of (in particular above or below) the conveying section, is present as a light structural unit in the form of a flat multilayer arrangement produced using PCB technology methods. The individual coils are each in the form of rectangular flat coils with helical windings. The windings of a coil may be located in a single layer, but may possibly also be distributed over two or more adjacent layers separated by insulation layers. In one exemplary embodiment, the multilayer arrangement also contains functional layers that act as an electric field shield against the penetration of electric fields into the detection zone. These are comb-like shielding elements that are connected to ground potential during operation.

The figures below are used to explain optional further components of the metal detector that can also improve its function.

In the exemplary embodiment of FIG. 6, plate-shaped field shaping elements 400 made of soft magnetic material are arranged above the upper coils and below the lower coils and laterally beside the through-channel. For example, these can be single plates made of ferrite or field shaping elements constructed from a plurality of plates. Such field shaping elements have a plurality of functions when used on a metal detector. On the one hand, the excitation field generated by the transmitting coil arrangements is shielded from the outside. Furthermore, any external alternating electromagnetic fields can be shielded against penetration into the detection zone. As a further positive effect, a field concentration or field amplification occurs in the region between the transmitting coils, i.e. in the region of the detection zone 120. This allows stronger electromagnetic fields to be generated with the transmitting coils within the detection zone under otherwise unchanged conditions than in the absence of the field shaping elements.

FIG. 5 schematically shows the simulated field distribution of the excitation field without the ferrite plates. The arrows above and below the detection zone 120 illustrate field lines that run outside the metal detector. FIG. 7, on the other hand, schematically shows what the field distribution looks like in the presence of the shielding by ferrite plates under otherwise identical conditions. Outside the shield formed by the ferrite plates 400, at most a weak field strength is present, which is symbolized by the absence of arrows. The strength of the shielding effect can be adjusted, among other things, via the thickness of the shielding elements used, which can be, for example, in the range from several millimeters up to 1 cm or more. The shielding effect and the field concentration effect increase with increasing thickness.

Further sensors that are useful when monitoring objects to be conveyed can also be attached to the metal detector. For example, a distance sensor may be provided, or alternatively or additionally a light barrier and alternatively or additionally at least one temperature sensor.

Here, the detection of pieces of metal in otherwise metal-free objects to be conveyed was explained by way of example. This is a typical application, e.g. in the field of the food industry, the pharmaceuticals industry, the plastics industry or more generally the chemical industry or the packaging industry.

A metal detector of the type described can also be used in other ways, e.g. in the field of metal sorting, which may involve, for example as part of recycling processes, after shredding recyclables in a conveying stream from shredder parts, identifying parts made of electrically highly conductive non-ferrous metals such as copper, aluminum or their alloys in order to thereby make it possible to separate them from constituents made of metals with poor conductivity and/or non-metals.

1.-14. (canceled)

15. A metal detector for detecting electromagnetically detectable constituents in objects to be conveyed, which objects comprise components made of materials of different electromagnetic properties and pass through a detection zone of the metal detector in a conveying direction along a conveying section, the metal detector comprising:
a support structure that defines a passage channel for the objects to be conveyed, the passage channel running in a longitudinal direction of the support structure from an inlet to an outlet for the objects to be conveyed;
a coil system comprising a multiplicity of coils which are arranged on the support structure and define the detection zone between the inlet and the outlet, wherein the multiplicity of coils comprise transmitting coils and receiver coils, including:
a first transmitting coil arrangement for generating a first excitation field in a first field direction oriented transversely to the longitudinal direction, wherein the first transmitting coil arrangement has first transmitting coils which are excitable in phase, are arranged on opposite sides outside the passage channel and have coil axes oriented transversely to the longitudinal direction;
a second transmitting coil arrangement for generating a second excitation field in a second field direction oriented transversely to the longitudinal direction, wherein the second transmitting coil arrangement has second transmitting coils which are excitable in phase, are arranged on opposite sides outside the passage channel and have coil axes oriented transversely to the longitudinal direction,
wherein the second transmitting coil arrangement is arranged with an offset in the longitudinal direction with respect to the first transmitting coil arrangement, and
wherein the second field direction is opposite the first field direction.

16. The metal detector as claimed in claim 15, wherein
the coil system does not have a transmitting coil surrounding the passage channel with a coil axis directed in the longitudinal direction.

17. The metal detector as claimed in claim 15, wherein
the first transmitting coil arrangement and the second transmitting coil arrangement are configured to be substantially axially symmetrical to an axis of symmetry that runs between the first and second transmitting coil arrangements perpendicular to their field direction.

18. The metal detector as claimed in claim 15, wherein the receiver coils comprise:
a first receiver coil and at least one second receiver coil which are arranged together on one side outside the passage channel beside one another with an offset with respect to one another in a transverse direction oriented perpendicular to the longitudinal direction,
wherein the first and the at least one second receiver coils have coil axes oriented transversely to the longitudinal direction.

19. The metal detector as claimed in claim 15, wherein
a receiver coil respectively surrounds a coil surface that extends in the longitudinal direction over the first transmitting coil arrangement and the second transmitting coil arrangement such that, absent a field disturbance, the first and second excitation fields induce equal and opposite voltages in the receiver coil.

20. The metal detector as claimed in claim 15, wherein
the coil system has, for each receiver coil on one side, a further receiver coil on that side of the passage channel which is opposite the one side,
wherein two receiver coils, which are assigned to one another and are arranged on different sides respectively, form a receiver coil pair, and
wherein receiver coils in a receiver coil pair that are assigned to one another have coil axes which are coaxial to one another.

21. The metal detector as claimed in claim 20, wherein
receiver coils which are directly adjacent and are arranged with an offset with respect to one another in the transverse direction directly adjoin one another or partially overlap in an overlapping region.

22. The metal detector as claimed in claim 19, wherein
receiver coils which are directly adjacent and are arranged with an offset with respect to one another in the transverse direction directly adjoin one another or partially overlap in an overlapping region.

23. The metal detector as claimed in claim 18, wherein
receiver coils which are directly adjacent and are arranged with an offset with respect to one another in the transverse direction directly adjoin one another or partially overlap in an overlapping region.

24. The metal detector as claimed in claim 15, wherein
the coil system, when viewed in the transverse direction, has two, three, four, or more receiver coil pairs with receiver coils that are coaxially opposite one another.

25. The metal detector as claimed in claim 15, wherein
the coils in the coil system are arranged in the form of rectangular flat coils with helically running windings in different coil layers of a multilayer arrangement, and
an insulating layer made of electrically insulating material is respectively arranged between adjacent coil layers of the multilayer arrangement.

26. The metal detector as claimed in claim 15, further comprising:
field shaping elements made of soft magnetic material which are arranged outside the coil arrangements at least in the region of the first and second transmitting coil arrangements.

27. The metal detector as claimed in claim 26, wherein the field shaping elements are in the form of ferrite plates.

28. The metal detector as claimed in claim 15, further comprising:
at least one electric field shield that is effective against penetration of electric fields into the detection zone,
wherein the electric field shield is integrated in a layer of a multilayer structure containing the coil arrangement.

29. The metal detector as claimed in claim 15, wherein
the support structure has, at least on one side, an access opening through which the passage channel is laterally accessible.

30. The metal detector as claimed in claim 15, wherein the support structure is oriented parallel to the conveying direction.

31. A method for detecting electromagnetically detectable constituents in objects to be conveyed, which objects comprise components made of materials of different electromagnetic properties and pass through a detection zone of a metal detector in a conveying direction along a conveying section, and which metal detector has transmitting coils and receiver coils,
wherein a transmitting coil generates an excitation field in the form of an alternating electromagnetic field which generates, in electromagnetically excitable constituents of the objects to be conveyed, eddy currents which result in a disruption in the alternating field which is detected by a receiver coil and evaluated by an evaluation device,
the method comprising:
passing the objects to be conveyed in direct temporal succession in the detection zone through two excitation field curtains which each extend in a transverse direction running transversely to the conveying direction over the conveying section and have field directions of the excitation field which are opposite and each run transversely to the conveying direction.

32. The method as claimed in claim 31, wherein
the receiver coils define two, three, four or more adjacent detection sectors in the transverse direction and, when evaluating the signals from the receiver coils, determine which detection sector a signal-triggering part has passed through.
